(19) United States
(12) Patent Application Publication
(10) Pub. No.: US 2007/0063910 A1
(43) Pub. Date: Mar. 22, 2007

(54) Antenna having wide transmitting angle

(75) Inventors: Huei Chi Wu, Tauyuan Hsien (TW); Jui Hsueh Chou, Tauyuan Hsien (TW)

Correspondence Address: CHARLES E. BAXLEY, ESQ., 90 JOHN STREET, THIRD FLOOR, NEW YORK, NY, 10038, US

(73) Assignee: Joymax Electronics Co., Ltd.

(21) Appl. No.: 11/231,608

(22) Filed: Sep. 20, 2005

(51) Int. Cl. H01Q 21/26

(52) U.S. Cl. 343/798; 343/700 MS

(57) ABSTRACT

An antenna assembly includes two antenna devices disposed one above the other and each having two end portions for signal transmitting purposes. The antenna devices each includes two antenna members attached to the end portions, and the antenna members of the antenna devices are preferably inclined relative to the antenna devices or extended oppositely relative to each other, for increasing the signal emitting and/or receiving or transmitting angles or ranges. A base board may include an extension to support the antenna devices, and having a positive terminal and a negative terminal coupling to the antenna devices.

### BACKGROUND OF THE INVENTION

1. Field of the Invention

The present invention relates to an antenna, and more particularly to an antenna assembly having different poles or different antenna members or devices for receiving and transmitting signals toward different directions, or for increasing the signal receiving and transmitting angles or ranges.

2. Description of the Prior Art

Typical antenna devices comprise an antenna disposed on or applied onto one side of a printed circuit board (PCB), for receiving and transmitting electric signals. Some of the typical antenna devices may further comprise a metal sheet disposed on or applied onto the other side of the PCB, for grounding purposes.

However, the antenna is disposed on one side of the PCB, and the magnetic field generated by the antenna may be polarized, such that the antenna may have two poles or two dead ends or dead corners where electric signals may not be suitably received and transmitted.

For solving the signals receiving and transmitting problems, some of the typical antenna devices comprise an antenna attached onto one side of a PCB with one or more legs, to suitably space the antenna from the PCB, and to allow electric signals to be suitably received and/or emitted or transmitted by the typical antenna devices.

For example, U.S. Pat. No. 6,255,994 to Saito, and U.S. Pat. No. 6,606,250 to Shi disclose two of the typical antenna devices and also comprise an antenna disposed on or attached onto one side of a PCB with one or more legs, for receiving and transmitting electric signals.

However, the typical antenna devices all comprise a planar structure, such that the signal receiving and/or emitting or transmitting angle is limited, and such that the typical antenna devices also may not be used to suitably receive and/or emit or transmit the signals.

The present invention has arisen to mitigate and/or obviate the afore-described disadvantages of the conventional antenna assemblies.

### SUMMARY OF THE INVENTION

The primary objective of the present invention is to provide an antenna assembly including two antenna devices superposed or attached together, for receiving and transmitting signals toward different directions, such as horizontally or laterally, and vertically or upwardly and downwardly.

In accordance with one aspect of the invention, there is provided an antenna assembly comprising a first antenna device and a second antenna device disposed one above the other, and each including two end portions for signal transmitting purposes, and for increasing the signal emitting and/or receiving or transmitting angles or ranges.

The first antenna device includes two antenna members attached to the end portions thereof respectively, for signals transmitting purposes. The antenna members of the first antenna device are inclined relative to the first antenna device. The antenna members of the first antenna device are extended oppositely relative to each other, for further increasing the signal emitting and/or receiving or transmitting angles or ranges.

The second antenna device also includes two antenna members attached to the end portions thereof respectively, for signals transmitting purposes. The antenna members of the second antenna device are inclined relative to the second antenna device. The antenna members of the second antenna device are extended oppositely relative to each other, for further increasing the signal emitting and/or receiving or transmitting angles or ranges.

Alternatively, the first antenna device includes a first antenna member attached to one of the end portions thereof, the second antenna device includes a second antenna member attached to one of the end portions thereof, and located close to the first antenna member of the first antenna device.

The first and the second antenna members are inclined relative to the first and the second antenna devices respectively. The first and the second antenna members of the first and the second antenna devices are extended oppositely relative to each other.

The first antenna device includes a third antenna member attached to the other end portion thereof, the second antenna device includes a fourth antenna member attached to the other end portion thereof, and located close to the third antenna member of the first antenna device.

The third and the fourth antenna members are inclined relative to the first and the second antenna devices respectively. The third and the fourth antenna members of the first and the second antenna devices are extended oppositely relative to each other, for further increasing the signal emitting and/or receiving or transmitting angles or ranges.

A base board may further be provided and may include an extension extended therefrom, for supporting the first and the second antenna devices, and/or for signal reflective purposes. The extension is preferably perpendicular to the base board. The base board is preferably made of metal or conductive materials. The extension of the base board includes a positive terminal and a negative terminal coupling to the first and the second antenna devices respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an antenna assembly in accordance with the present invention;

FIG. 2 is a partial exploded view of the antenna assembly; and

FIG. 3 is a diagram illustrating tests conducted by two of the typical antenna devices and the antenna assembly.

### DETAILED DESCRIPTION OF THE PREFERRED EMBODIMENT

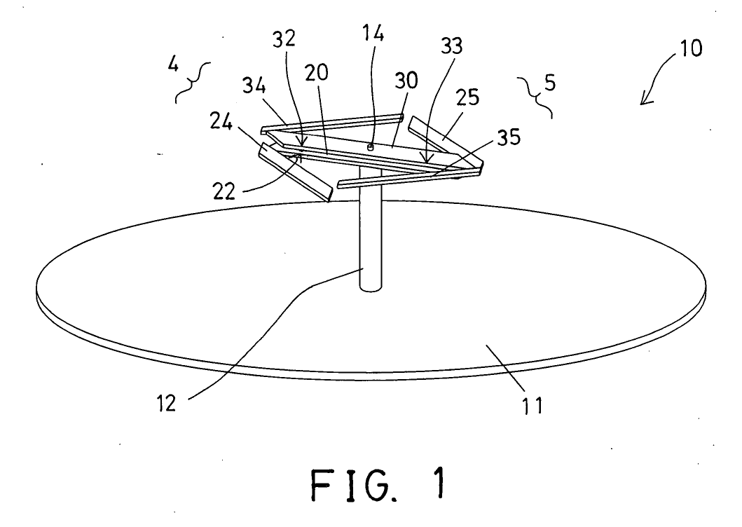

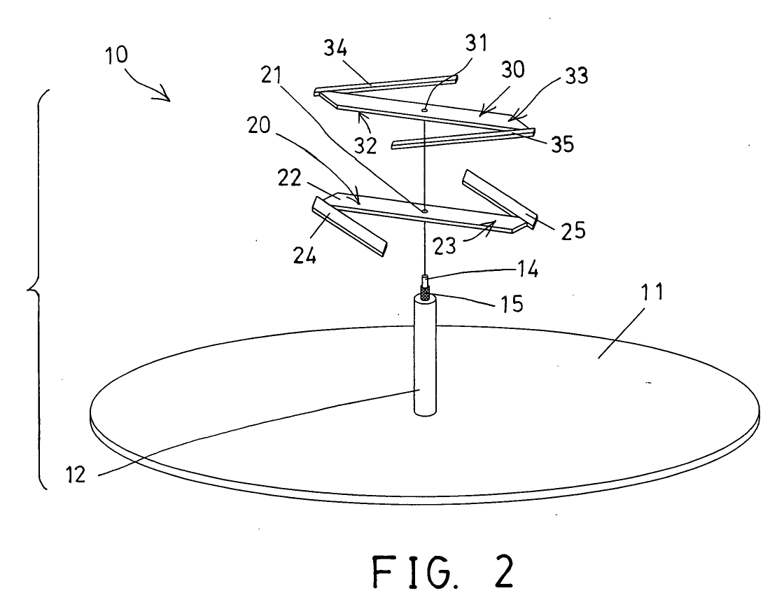

Referring to the drawings, and initially to FIGS. 1 and 2, an antenna assembly 10 in accordance with the present invention comprises a base board 11 made of such as metal materials, for such as signal reflective purposes, and including an extension 12 extended therefrom, such as perpendicular thereto, and having a positive terminal 14 and a negative terminal 15 provided thereon or extended therefrom, for signal emitting and/or receiving or transmitting purposes.

The antenna assembly 10 further includes two separated antenna devices 20, 30 each having an orifice 21, 31 formed therein, for receiving the negative terminal 15 and the positive terminal 14 of the extension 12 respectively, for electrically or conductively coupled to the negative terminal 15 and the positive terminal 14 of the extension 12 respectively, and for allowing the two antenna devices 20, 30 to be superposed with each other, or disposed on above the other.

The antenna devices 20, 30 each includes two end portions 22, 23; 32, 33 for signal emitting and/or receiving or transmitting purposes, and each having an antenna member 24, 25; 34, 35 disposed thereon or attached thereto, and preferably inclined relative to the antenna devices 20, 30 respectively, or extended upwardly or downwardly or inclinedly relative to the antenna devices 20, 30 respectively, for increasing the signal emitting and/or receiving or transmitting angles or ranges.

It is preferable that the antenna members 24, 25 at different end portions 22, 23 of the antenna device 20 are extended oppositely or extended toward different directions. For example, when the antenna member 24 of one of the antenna devices 20 extends downwardly relative to the antenna device 20, then the other antenna member 25 of the same antenna device 20 preferably extends upwardly relative to the antenna device 20, and vice versa.

Similarly, when the antenna member 35 of the other antenna device 30 extends downwardly relative to the antenna device 30, then the other antenna member 34 of the same antenna device 30 extends upwardly relative to the antenna device 30, and vice versa, for further increasing the signal emitting and/or receiving or transmitting angles or ranges.

It is further preferable that the antenna members 24, 34 located at the end portions 22, 23 of the antenna devices 20, 30 that are adjacent to each other extend oppositely or extend toward different directions. For example, when the antenna member 24 of one of the antenna devices 20 extends downwardly relative to the antenna device 20, then the antenna member 34 of the other antenna device 30 extends upwardly relative to the antenna device 30, and vice versa.

Similarly, when the antenna member 35 of the other antenna device 30 extends downwardly relative to the antenna device 30, then the antenna member 25 of the antenna device 20 extends upwardly relative to the antenna device 20, and vice versa, for further increasing the signal emitting and/or receiving or transmitting angles or ranges, such that there will be no dead ends or dead corners formed or generated or occurred by the antenna devices 20, 30.

The antenna members 24, 34 of the antenna devices 20, 30 that are electrically or conductively coupled to the negative terminal 15 and the positive terminal 14 of the extension 12 respectively may form a signal emitting and/or receiving or transmitting portion 4 for the antenna assembly 10 (FIG. 1). Similarly, the other antenna members 25, 35 of the antenna devices 20, 30 that are electrically or conductively coupled to the negative terminal 15 and the positive terminal 14 of the extension 12 respectively may also form another signal emitting and/or receiving or transmitting portion 5 for the antenna assembly 10 (FIG. 1).

The base or reflective board 11 may further be used for signal reflective purposes, and thus for further increasing the signal emitting and/or receiving or transmitting angles or ranges for the antenna assembly 10.

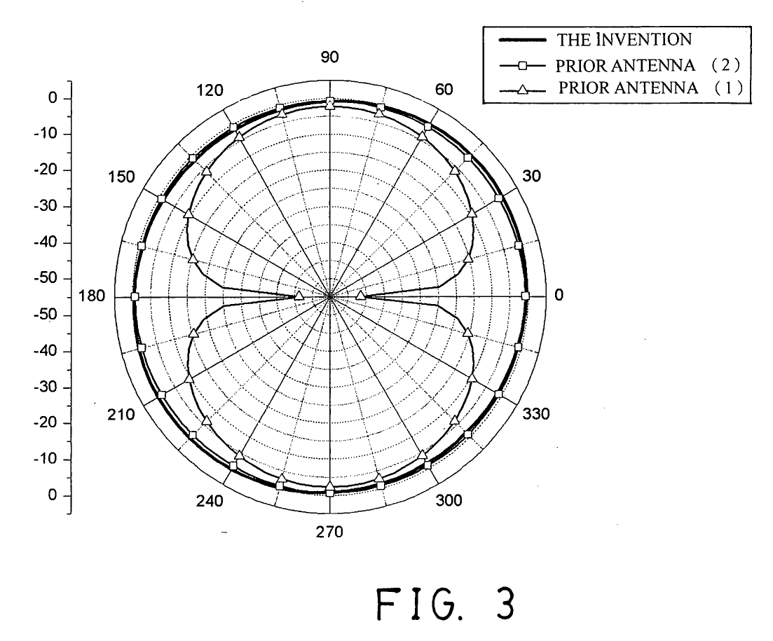

As shown in FIG. 3, illustrated are the test results conducted with the antenna assembly in accordance with the present invention and two prior or conventional antenna devices, in which the antenna assembly in accordance with the present invention has a wider or greater signal emitting and/or receiving or transmitting angles or range than that of the prior or conventional antenna devices.

Accordingly, the antenna assembly in accordance with the present invention includes two antenna devices superposed or attached together, for receiving and transmitting signals toward different directions, such as horizontally or laterally, and vertically or upwardly and downwardly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna assembly comprising:
a first antenna device and a second antenna device disposed one above the other, and each including two end portions for signal transmitting purposes.

2. The antenna assembly as claimed in claim 1, wherein said first antenna device includes two antenna members attached to said end portions thereof respectively, for signals transmitting purposes.

3. The antenna assembly as claimed in claim 2, wherein said antenna members of said first antenna device are inclined relative to said first antenna device.

4. The antenna assembly as claimed in claim 2, wherein said antenna members of said first antenna device are extended oppositely relative to each other.

5. The antenna assembly as claimed in claim 1, wherein said second antenna device includes two antenna members attached to said end portions thereof respectively, for signals transmitting purposes.

6. The antenna assembly as claimed in claim 5, wherein said antenna members of said second antenna device are inclined relative to said second antenna device.

7. The antenna assembly as claimed in claim 5, wherein said antenna members of said second antenna device are extended oppositely relative to each other.

8. The antenna assembly as claimed in claim 1, wherein said first antenna device includes a first antenna member attached to one of said end portions thereof, said second antenna device includes a second antenna member attached to one of said end portions thereof, and located close to said first antenna member of said first antenna device.

9. The antenna assembly as claimed in claim 8, wherein said first and said second antenna members are inclined relative to said first and said second antenna devices respectively.

10. The antenna assembly as claimed in claim 8, wherein said first and said second antenna members of said first and said second antenna devices are extended oppositely relative to each other.

11. The antenna assembly as claimed in claim 8, wherein said first antenna device includes a third antenna member attached to the other end portion thereof, said second antenna device includes a fourth antenna member attached to the other end portion thereof, and located close to said third antenna member of said first antenna device.

12. The antenna assembly as claimed in claim 11, wherein said third and said fourth antenna members are inclined relative to said first and said second antenna devices respectively.

13. The antenna assembly as claimed in claim 11, wherein said third and said fourth antenna members of said first and said second antenna devices are extended oppositely relative to each other.

14. The antenna assembly as claimed in claim 1 further comprising a base board including an extension extended therefrom, for supporting said first and said second antenna devices.

15. The antenna assembly as claimed in claim 14, wherein said extension is perpendicular to said base board.

16. The antenna assembly as claimed in claim 14, wherein said base board is made of metal materials.

17. The antenna assembly as claimed in claim 14, wherein said extension of said base board includes a positive terminal and a negative terminal coupling to said first and said second antenna devices respectively.
